(19) United States
(12) Patent Application Publication
(10) Pub. No.: US 2006/0004576 A1
(43) Pub. Date: Jan. 5, 2006

(54) Server device

(76) Inventor: Ken Kishida, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,170

(22) Filed: Jun. 30, 2005

(30) Foreign Application Priority Data
Jun. 30, 2004 (JP) 2004-192933

(51) Int. Cl. G10L 13/08

(52) U.S. Cl. 704/258

(57) ABSTRACT

When a third database element for acquiring a second content of a second server connected to a channel is registered in a first database, a registration and deletion unit refers to a device description to determine whether the second server requires a transfer-preparation request before the content is transferred. If the transfer-preparation request is required, the registration and deletion unit rewrites the URL of the content so as to trace the content via a relay unit. When a playback unit requires the second content, the relay unit serves as an intermediate for acquiring the second content while transmitting a transfer-preparation request and a transfer-completion request to a control unit of the second server in place of the playback unit.

### CROSS-REFERENCE TO RELATED APPLICATIONS

This application is based upon and claims the benefit of priority from prior Japanese Patent Application No. 2004-192933, filed Jun. 30, 2004, the entire contents of which are incorporated herein by reference.

### BACKGROUND OF THE INVENTION

1. Field of the Invention

The present invention relates to contents management technology in digital versatile disk (DVD) recorders and the like.

2. Description of the Related Art

Remarkable improvements have recently been made in compressing and encoding technology and expanding and decoding technology and contents including moving images can be handled easily via a network (see, for example, Jpn. Pat. Appln. KOKAI Publication No. 2001-155022). Some users have a plurality of DVD recorders (server devices) connected to the same home network. For users' operability, the server devices have a function of making the contents of all the server devices available using any one of the server devices as an entrance.

The above function is fulfilled if the entrance server device collects and manages the uniform resource locators (URL) of contents of the other server devices. In order to use the contents in a playback unit such as a personal computer via a network, a user has only to gain access to only a specific server device wherever the contents are located. The user's operability can thus be improved.

Some server devices do not transfer any contents without receiving a transfer-preparation request. More specifically, even though a user acquires the URL of a desired content from an entrance server device and traces another server device having the content based on the URL to request the transfer of the content, a transfer-preparation request has been transmitted to the entrance server device and thus it is not transmitted to the other server devices, with the result that the content is not transferred.

A server device that requires a transfer-preparation request generally requires a transfer-completion request when it completes transferring a content. Naturally, the transmission of this transfer-completion request is not taken into consideration and thus becomes impossible.

### BRIEF SUMMARY OF THE INVENTION

According to an embodiment of the present invention, a server device that receives a request for contents from a playback unit connected to the server device via a network, comprises a database which stores related information of each of the contents, the related information including a location of each of the contents and causing the playback unit to select and acquire a desired content; a retrieving unit configured to retrieve another server device connected to the network; a registering unit configured to create related information of a content of a retrieved server device and to store the related information in the database, when the retrieving unit retrieves the another server device; and a relay unit configured to transmit a transfer-preparation request to the another server device, then acquires the content from the another server device, and transfers the content to the playback unit, when the content of the another server device is requested from the playback unit, wherein the registering unit determines whether or not the another server device requires the transfer-preparation request before the content is transferred, creates related information described a location of the content such that the another server device is directly traced and stores the related information in the database when the transfer-preparation request is not required, and creates related information described the location of the content such that the another server device is traced via the relay unit and stores the related information in the database when the transfer-preparation request is required.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a home network system configured by a server device according to an embodiment of the present invention;

FIG. 2 is a block diagram of a home network system configured by a prior art server device;

FIG. 3 is a flowchart showing a first operating procedure of a registration and deletion unit of the server device according to the embodiment of the present invention;

FIG. 4 is a flowchart showing a second operating procedure of the registration and deletion unit of the server device according to the embodiment of the present invention; and

FIG. 5 is a flowchart showing an operating procedure of a relay unit of the server device according to the embodiment of the present invention.

### DETAILED DESCRIPTION OF THE INVENTION

An embodiment of the present will be described with reference to the accompanying drawings.

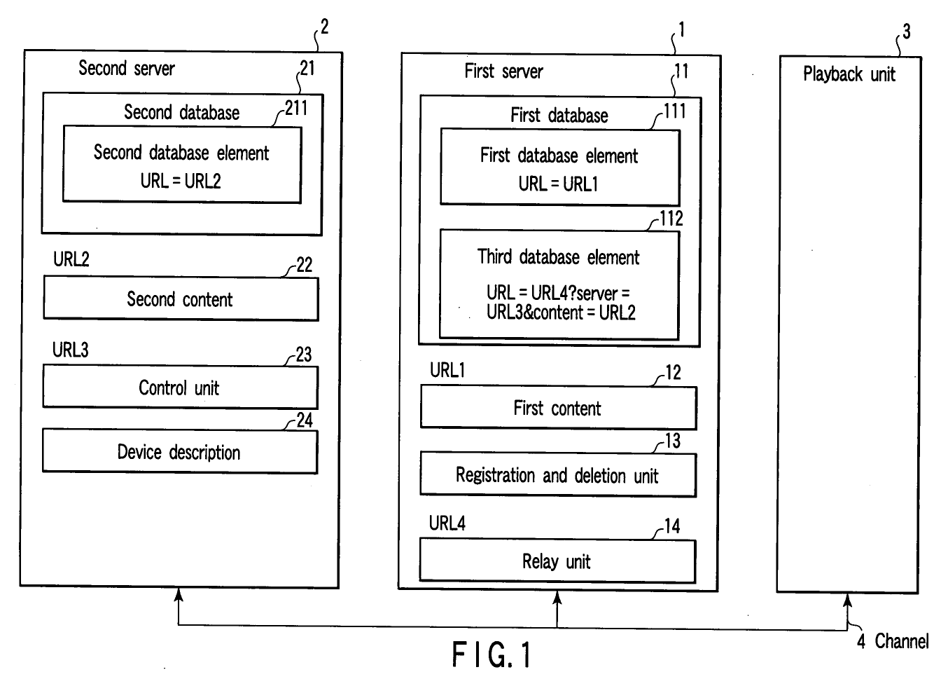

FIG. 1 is a block diagram of a home network system configured by a server device according to an embodiment of the present invention. Referring to FIG. 1, a first server 1, a second server 2 and a playback unit 3 are connected via a channel 4 in the home network system. For easy understanding, FIG. 1 shows one second server 2 and one playback unit 3. However, two or more second servers 2 can be connected to the home network system, as can be two or more playback units 3. The present embodiment is based on the premise that a universal plug and play (UPnP) Media Server, a UPnP Media Renderer and a UPnP control point are applied to the home network system.

The first server 1 is a server device according to the present embodiment and corresponds to the UPnP Media Server. The first server 1 includes a first database 11, a first content 12, a registration and deletion unit 13 and a relay unit 14. The first database 11 and first content 12 are data sections configured on a storage medium of the first server 1. The registration and deletion unit 13 and relay unit 14 are processing sections generated as a result of executing related programs by a processor of the first server 1.

The first database 11 corresponds to UPnP Content Directory Service and stores a first database element 111 and a third database element 112. The first database element 111 describes meta information about the first content 12 in the first server 1 itself. This meta information includes the URL of the content (“URL1” as the URL of the first content 1). The third database element 112 describes meta information about the second content 22 in the second server 2. This meta information also includes a URL; however, this URL is not the URL of the second content 22 but a combination of the URL of the relay unit 14, that of a control unit 23 in the second server 2 and that of the second content 22 (“URL4?server=URL3&content=URL2”). The third database element 112 is created by the registration and deletion unit 13 in the steps described later.

The first content 12 is included in the first server 1 and can be read out by “URL1.” When the registration and deletion unit 13 detects on the channel 4 a server (second server 2) other than the server (first server 1) to which the unit 13 belongs, it fetches a database element (second database element 211) from the database (second database 21) of the detected server and stores it in the first database 11. This stored database element is the third database element 112 descried above. The registration and deletion unit 13 allows the contents of two or more servers on the channel 4 to be read by the first database 11 in a unified way.

Assume in the present embodiment that the second server 2 requires a transfer-preparation request before its content is transferred. The registration and deletion unit 13 refers to a device description 24 (described later) of the second server 2 to recognize that the second server 2 requires the transfer-preparation request before its content is transferred, rewrite the URL of the second database element 211 as described above, and store it in the third database 112. In other words, the third database element 112 stores a combination of “URL4” as the URL of the relay unit 14, “URL3” as the URL of the control unit 23 of the second server 2 and “URL2” as the URL of the second content 22 in the form of URL4?server=URL3&content=URL2.

When the second server 2 does not require any transfer-preparation request, the registration and deletion unit 13 stores “URL2” in the third database element 112 as the URL of the second content 22. When the second server 2 disappears from the channel 4, the unit 13 deletes the database element from the first database 11.

As a result of rewriting the URL of the database element to include the URL of the relay unit 14 itself as described above, if the relay unit 14 is required a content from the playback unit 3, the relay unit 14 sends a transfer-preparation request to the control unit 23 of “URL3” that is included in the URL of the required content in the form of “URL4?server=URL3&content=URL2.” Then, the relay unit 14 acquires the content by “URL2” and transfers it to the playback unit 3. When the relay unit 14 completes transferring the content, it issues a transfer-completion request to the control unit 23 of “URL3.”

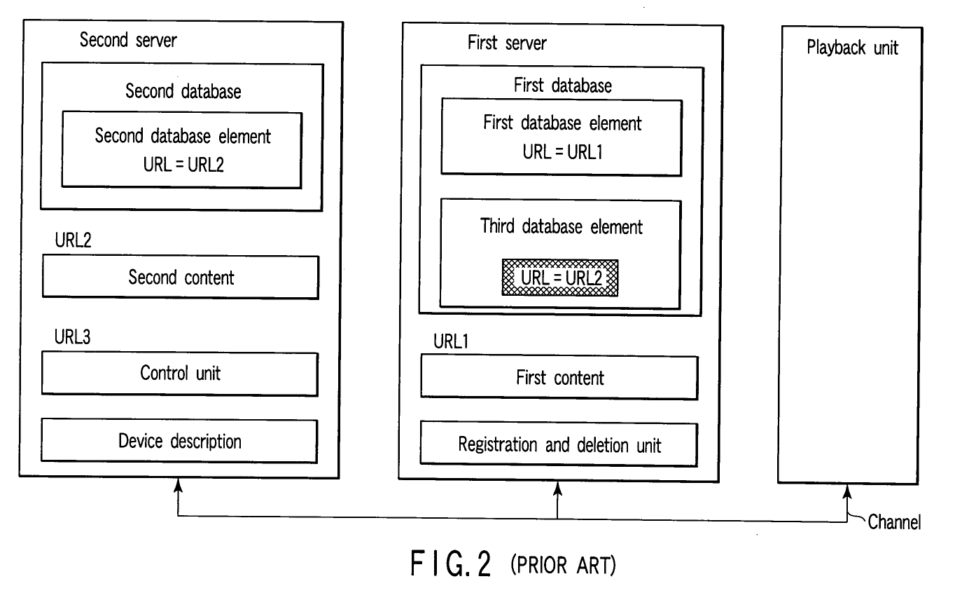

In order to clarify the differences between the server device of the present embodiment and the prior art server device, FIG. 2 shows a home network system configured by the prior art server device. In the system shown in FIG. 2, the URL of the second content is stored in the third database element as it is though the second server requires a transfer-preparation request and a transfer-completion request. This system does not include any relay unit serving as an intermediate for acquiring the second content while transmitting a transfer-preparation request and a transfer-completion request to the second server.

Though the second server 2, playback unit 3 and channel 4 of the present embodiment are the same as those of the prior art home network system, they will be described briefly below.

Like the first server 1, the second server 2 corresponds to the UPnP Media Server and includes the second database 21, second content 22, control unit 23 and device description 24.

The second database 21 corresponds to the UPnP Content Directory Service and stores the second database element 211. Like the first database element 111 in the first server 1, the second database element 211 describes meta information about the second content 22 in the second server 2 itself. This meta information includes the URL of the content (“URL2” as the URL of the second content 22). The second content 22 is included in the second server 2 and can be read by “URL2.”

The control unit 23 corresponds to, for example, a UPnP ConnectionManager Service and controls the transmission of contents from the second server 2. Upon receiving a transfer-preparation request such as a UPnP PrepareForConnection Action, the control unit 23 prepares to transmit a content. After the content is transmitted, the control unit 23 receives a transfer-completion request such as a UPnP ConnectionComplete Action.

The device description 24 corresponds to, for example, a UPnP device description and a service description and describes information about the second server 2. Referring to the device description 24, a user can determine whether or not the second server 2 requires a transfer-preparation request prior to the transfer of a content.

The playback unit 3 corresponds to, for example, a Media Renderer and a control point, and fetches a content from a server and plays it back. Prior to this playback, the playback unit 3 fetches database elements 111 and 112 from the first database 11 in the first server 1 and presents them to a user. If the user selects one of the database elements, the playback unit 3 traces the URL of the selected one to acquire its content and play it back. The channel 4 connects each of the servers and the playback unit to transfer information and contents between them.

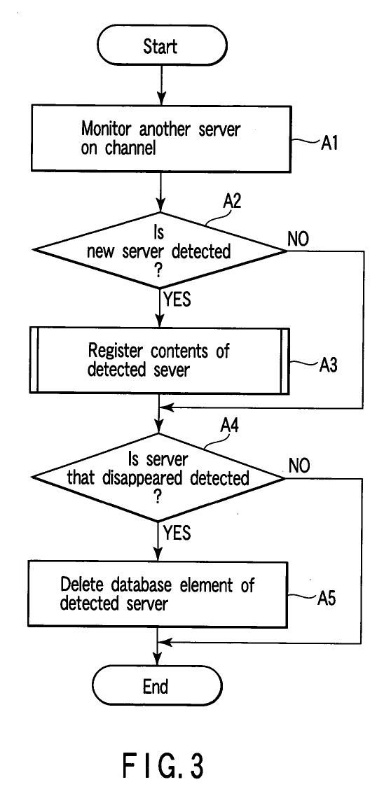

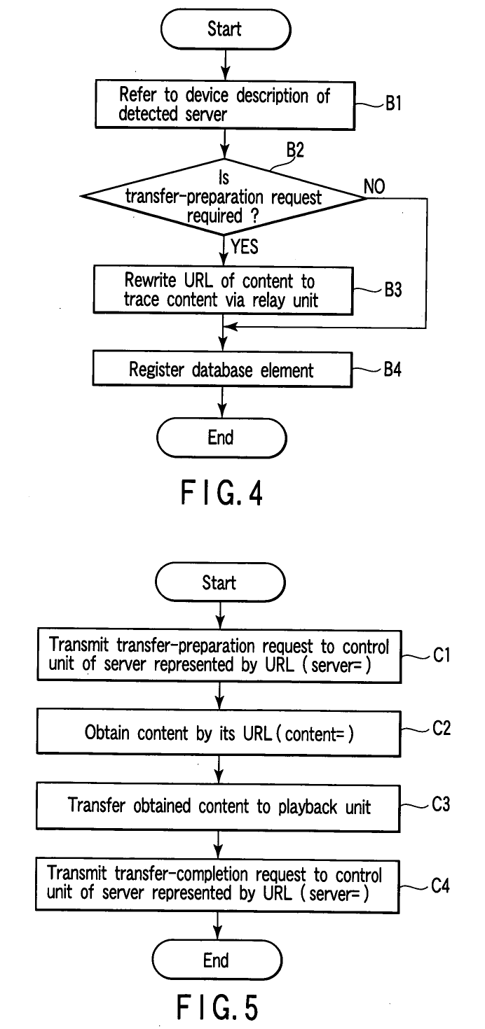

The operating principle of the server device according to the present embodiment will be described with reference to FIGS. 3 to 5. FIGS. 3 and 4 are flowcharts showing an operating procedure of the registration and deletion unit 13 in the first server 1.

The registration and deletion unit 13 monitors another server device connected to the channel 4 at regular time intervals (step A1). If the unit 13 detects a new server device (YES in step A2), it registers the content of the detected server device (step A3). FIG. 4 shows a flow of this registration.

The registration and deletion unit 13 refers to the device description of the detected server device (step B1) and determines whether or not the detected server device requires a transfer-preparation request based on the device description (step B2). If the transfer-preparation request is required (YES in step B2), the unit 13 rewrites the URL of the content to trace the content via the relay unit (step B3) and stores the database element in the database (step B4). If it is not required (NO in step B2), the unit 13 stores the database element without modification in the database (step B4).

If the unit 13 detects a server device that disappeared from the channel 4 (YES in step A4), it deletes the database element of the content of the server device from the database (step SA5).

FIG. 5 is a flowchart showing an operating procedure of the relay unit 14.

When the relay unit 14 is requested a content from the playback unit, the relay unit 14 transmits a transfer-preparation request to a server device represented by the URL of the content (step C1). After the transfer-preparation request is transmitted, the relay unit 14 acquires the requested content from the server device by the URL (step C2) and transfers it to the playback unit (step C3).

When the relay unit 14 completes acquiring the content from the server device and transferring it to the playback unit, it transmits a transfer-completion request to the server device (step C4).

As described above, in the server device (first server 1) of the present embodiment, the registration and deletion unit 13 determines whether or not a transfer-preparation request is required when it stores a database element about the content of another server device (second server 2) connected to the channel 4. If the transfer-preparation request is required, the unit 13 rewrites the URL of the content to trace the content via the relay unit 14. The relay unit 14 serves as an intermediate for obtaining a desired content while transmitting a transfer-preparation request and a transfer-completion request to another server device. Consequently, the contents of another server device that requires a transfer-preparation request and a transfer-completion request can be used appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server device that receives a request for contents from a playback unit connected to the server device via a network, comprising:
a database which stores related information of each of the contents, the related information including a location of each of the contents and causing the playback unit to select and acquire a desired content;
a retrieving unit configured to retrieve another server device connected to the network;
a registering unit configured to create related information of a content of a retrieved server device and to store the related information in the database, when the retrieving unit retrieves the another server device; and
a relay unit configured to transmit a transfer-preparation request to the another server device, then acquires the content from the another server device, and transfers the content to the playback unit, when the content of the another server device is requested from the playback unit,
wherein the registering unit determines whether or not the another server device requires the transfer-preparation request before the content is transferred, creates related information described a location of the content such that the another server device is directly traced and stores the related information in the database when the transfer-preparation request is not required, and creates related information described the location of the content such that the another server device is traced via the relay unit and stores the related information in the database when the transfer-preparation request is required.

2. The server device according to claim 1, wherein the relay unit transmits a transfer-completion request to the another server device when the relay unit completes acquiring the content.

3. The server device according to claim 1, wherein the related information of each of the contents includes a uniform resource locator (URL), and the registering unit controls whether or not to rewrite the URL to include a URL of the relay unit according to whether or not the transfer-preparation request is required.

4. The server device according to claim 1, wherein the transfer-preparation request is a universal plug and play (UPnP) PrepareForConnection Action.

5. The server device according to claim 2, wherein the transfer-completion request is a UPnP ConnectionComplete Action.

6. The server device according to claim 1, further comprising a deleting unit configured to delete the related information of the content of the another server device from the database when the retrieving unit does not retrieve the another server device.

7. The server device according to claim 1, wherein the registering unit acquires a device description that describes information about the another server device from the another server device, and determines whether or not the transfer-preparation request is required based on the device description.

8. The server device according to claim 7, wherein the device description is a UPnP device description and a service description.
